(19) United States
(12) Patent Application Publication
(10) Pub. No.: US 2016/0050939 A1
(43) Pub. Date: Feb. 25, 2016

(54) SYSTEM TO PREVENT INCORRECT FINGER PLACEMENT IN CONVEYOR OVENS

(71) Applicant: CLEVELAND RANGE, LLC, Cleveland, OH (US)

(72) Inventors: Gary Grant RIGGLE, Lyndhurst, OH (US); Nelson PITLOR, Twinsburg, OH (US)

(21) Appl. No.: 14/830,250

(22) Filed: Aug. 19, 2015

Related U.S. Application Data
(60) Provisional application No. 62/039,271, filed on Aug. 19, 2014.

(51) Int. Cl. A21B 1/24; A21B 1/26

(52) U.S. Cl. CPC A21B 1/245; A21B 1/26

(57) ABSTRACT

The duct assembly of the present disclosure includes one or more air impingement ducts and a plenum plate for receiving the impingement duct. Each impingement duct includes a housing, a columnating plate with one or more columnating orifices, and a cover plate with one or more cover orifices. The housing, columnating plate, and cover plate are arranged in stacked arrangement, and collectively define an interior space in the duct. Heated air is passed through the interior space and out through the orifices. At least one of the plenum plate, housing, columnating plate, and cover plate includes a mechanical feature that mates with a corresponding feature on another of the duct components, to ensure that only specific duct components can be assembled together. In one embodiment, the columnating plate includes a pin protruding with an end that mates with a corresponding notch on the cover plate. In another embodiment, the housing has an angled side or flange that mates with a corresponding angles flange on the plenum plate.

### CROSS-REFERENCE TO RELATED APPLICATIONS

The present disclosure claims priority to U.S. Provisional Patent Application No. 62/039,271, filed on Aug. 19, 2014, which is herein incorporated by reference.

### BACKGROUND OF THE DISCLOSURE

1. Field of the Disclosure

The present disclosure related to impingement ovens. More particularly, the present disclosure relates to an impingement with one or more impinging air ducts (or “finger” ducts) that have a keyed system to insure proper assembly.

2. Discussion of the Related Art

Impinging air ducts in impingement ovens, also known as “finger” ducts, each consist of three parts: a housing, a cover plate, and a columnating plate. The housing is connected to and receives heated air from a plenum, and this heated air is directed out from an interior space defined by the housing, and through orifices in the columnating plate and cover plate toward a food product. The columnating plate has one or more apertures therein, and help to columnate the heated air into jets. In some cases, with respect to assembly, the three-part finger ducts are interchangeable with most, if not all, of the other finger ducts within a given oven.

In ovens sold to customers, each columnating plate may have a different arrangement of orifices thereon, to accommodate for the unique parameters of the customer's application. Customers typically rely on the correct part and finger placement in the oven. Variations from the intended position of each finger duct will change the performance of the oven. Since finger ducts in current devices are interchangeable mechanically with respect to how they may connect to a plenum, the correct placement cannot be easily guaranteed. Incorrect duct assembly and placement is common, especially after disassembly to clean.

The present disclosure addresses these disadvantages of current systems.

### SUMMARY OF THE DISCLOSURE

The present disclosure provides impingement ovens where each impingement or finger duct has a unique keyed system that prevents incorrect assembly, guarantees intended oven performance, and simplifies the training process for cleaning personnel. This unique keyed system also assures that the impingement oven leaves the factory with the intended finger part positioning. As described in greater detail below, one or more of the housing, cover plate, and columnating plate has a mechanical feature that only mates with a specific corresponding feature on another part of the duct.

Thus, in one embodiment, the present disclosure provides an impinging air duct, comprising a housing, a columnating plate having one or more columnating orifices, and a cover plate having one or more cover plate orifices. The housing, the columnating plate, and the cover plate are connected to one another in stacked vertical alignment. At least one of the housing, the columnating plate, and the cover plate comprises a unique mechanical feature that mates with a corresponding feature on another of the housing, the columnating plate, and the cover plate.

In another embodiment, the present disclosure provides a duct assembly, comprising an impingement air duct, and a plenum plate to receive the impingement duct. The duct comprises a housing, a columnating plate having one or more columnating orifices, and a cover plate having one or more cover plate orifices. The housing, the columnating plate, and the cover plate are connected to one another in stacked vertical alignment. At least one of the plenum plate, the housing, the columnating plate, and the cover plate comprises a unique mechanical feature that mates with a corresponding feature on another of the housing, the columnating plate, and the cover plate.

The present disclosure also provides an impingement oven comprising a cooking chamber, a conveyor, at least one plenum, and a plurality of finger duct members attached to each plenum which are located above and below the conveyor, or a plenum disposed in the rear of the conveyor. Each finger duct member includes an angled or rectangular housing, a cover and a columnating or jet plate disposed therebetween. Moreover, not all finger duct members have the same arrangement of apertures in said columnating plate, hence it is critical to ensure that during assembly and/or replacement that the appropriate components of each unique finger duct member is assembled together and positioned about the plenum in the appropriate order so that the oven functions properly. The present disclosure provides a unique keyed system to prevent incorrect finger placements about the plenum in the conveyor oven, as well as the correct assembly of each finger duct member.

The present disclosure also provides a finger system comprising: a plurality of finger duct members each comprising a housing, a cover and a columnating plate disposed therebetween, the members including a first end and second end, wherein at least some or all of the columnating plates comprise a pin and at least some or all of the covers comprise a first slot and/or wherein at least some or all of the covers comprises a tab and at least some or all of the housings include a second slot, thereby preventing the incorrect assembly of each of the finger duct members; and/or a front plenum plate comprising angled or shaped flanges which are configured to receive the first end of each of the finger duct members, wherein each the first end of a respective angled or shaped housing of each the finger duct member comprises a unique angle which matches the angled or shaped flanges of the front plenum plate, thereby preventing the incorrect order placement of the finger duct members in the finger system. The angled housing can include rectangular shapes with an interfering design feature, such as a perturbation, protuberance, pin, slot receptacle, etc.

The finger system further comprises a first support rail configured to receive the second end of the finger duct members, the first support rail comprising a plurality of notches which are aligned to receive the pins of each of the respective finger duct member, thereby preventing the incorrect order placement of the finger duct members in the finger system.

Optionally, the front plenum plate receives a plurality of the finger duct members in an upper position and a plurality of the finger duct members in a lower position.

The finger system further comprises at a second support rail, wherein the first support rail received a plurality of the finger duct members in an upper position and a plurality of the finger duct members in a lower position.

According to another embodiment, a finger duct member comprises: a housing, a cover and a columnating plate disposed therebetween, wherein the columnating plate comprise a pin and the cover comprises a first slot, wherein the pin aligns with the first slot, thereby preventing the incorrect assembly of the finger duct member. The finger duct member further comprises a tab affixed to the cover and a second slot disposed in the housing, wherein the tab aligns with the second slot, thereby preventing the incorrect assembly of the finger duct member.

Still yet another embodiment, a finger duct member comprises: a housing, a cover and a columnating plate disposed therebetween, wherein the cover comprising a tab and the housing comprises a slot, wherein the tab aligns with the slot, thereby preventing the incorrect assembly of the finger duct member.

Alternatively, the pin would be in the housing, and the hole in the columnating plate.

Further objects, features and advantages of the present disclosure will be understood by reference to the following drawings and detailed description.

### BRIEF DESCRIPTION OF THE DRAWINGS

FIG. 1 is an exploded view of an impingement duct assembly comprising four upper and four lower impingement ducts according to the present disclosure;

FIG. 2 is perspective view of a first end of an impingement duct adjacent a plenum assembly;

FIG. 3 is a top left-side perspective view of second ends of the four upper impingement ducts of FIG. 1, adjacent an upper notched support rail;

FIG. 4 is a top left-side perspective view of second ends of the four lower impingement ducts of FIG. 1, adjacent a lower notched support rail;

FIG. 5 is a perspective view of notches in an upper support rail which align with respective keys or pins of the associated impingement ducts adjacent thereto;

FIG. 6 depicts a plenum assembly with angled or shaped flanges to match the housing of associated impingement ducts;

FIG. 7 depicts an upper support rail with three notches to receive the key or pin from the associated upper impingement ducts;

FIG. 8 depicts a lower support rail with three notches to receive the key or pin from the associated lower impingement ducts;

FIG. 9 is an upper impingement duct with an angled or shaped housing and no key or pin;

FIG. 10 is an upper impingement duct with an angled or shaped housing and a pin protruding from the columnating plate and slot in the cover which is aligned with the pin;

FIG. 11 is an upper impingement duct with an angled or shaped and slotted housing, a pin protruding from the columnating plate and slot in the cover which is aligned with the pin, wherein the cover also include a tab that matches the slot in the housing;

FIG. 12 is an upper impingement duct with an angled or shaped and slotted housing, a pin protruding from the right side of a columnating plate and slot disposed in the center of the cover which is aligned with the pin, wherein the cover also include a tab that matches the slot in the housing;

FIG. 13 is a lower impingement duct with an angled or shaped housing and a pin protruding from the columnating plate and slot in the cover which is aligned with the pin disposed on the left side of the lower finger assembly;

FIG. 14 is a lower impingement duct with an angled or shaped housing and no key or pin disposed to the right of the lower impingement duct of FIG. 13;

FIG. 15 is a lower impingement duct with an angled or shaped housing and no key or pin disposed to the right of the lower impingement duct of FIG. 14; and

FIG. 16 is a lower impingement duct with an angled or shaped housing and a pin protruding from the columnating plate and slot in the cover which is aligned with the pin disposed on the left side of the lower finger assembly, which member is disposed to the right of the lower impingement duct of FIG. 15.

### DETAILED DESCRIPTION OF THE DISCLOSURE

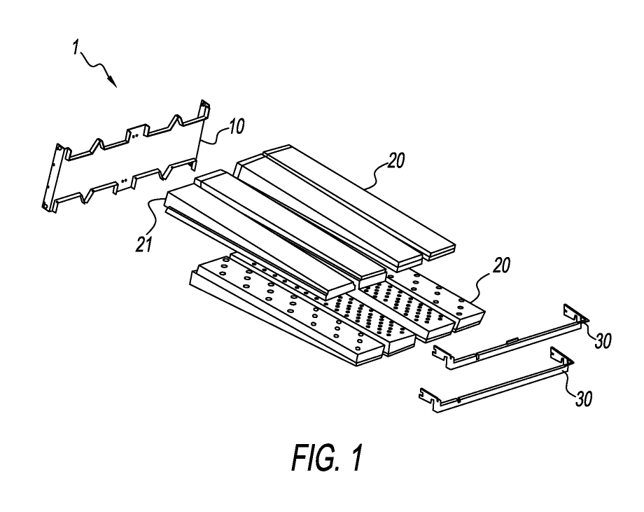

Referring to the Figures, and in particular FIG. 1, duct assembly 1 includes plenum plate 10, one or more impingement ducts 20, and optionally, one or more support rails 30. In the shown embodiments, there are four upper impingement ducts 20 and four lower impingement ducts 20, but the present disclosure contemplates one or more upper ducts, one or more lower ducts, or one or more of each. A conveyor (not shown) would carry a food product (not shown) below upper ducts 20, above lower ducts 20, or between the two. Each impingement duct 20 has an associated housing 22, with an interior space 24, a columnating plate 26 having one or more columnating orifices 27, and a cover plate 28 having one or more cover orifices 29. Housing 22, columnating plate 26, and cover plate 28 are connected to one another in stacked vertical arrangement, and collectively define interior space 24. The food product would be cooked, heated, or warmed by air impinging on the food product after passing from interior space 24, and out through orifices 27, 29.

As previously discussed, each of the columnating plates and/or the cover plates may have a different arrangement of orifices 27, 29 thereon. As described in greater detail below, at least one of plenum plate 10, housings 24, columnating plate 26, and/or cover plate 28 of the present disclosure include at least one mechanical connection feature that is unique, and only allows that component to be connected to specific associated components. This ensures that impingement duct(s) 20 are placed back in their proper locations after being removed for cleaning. For example, if an operator removes duct 20, and attempts to connect a housing 22 to a cover plate 28 that does not have the proper matching feature, the operator will know that the parts are mismatched or mislocated.

As previously, discussed, in each of ducts 20, housing 22, columnating plate 26, and cover plate 28 are connected to one another in layered arrangement. One example is shown in FIG. 9. Heated air enters a first, open end 21 of duct 20, and is then passed out through orifices 27 and 29 of plates 26 and 28, respectively. Housing 22 can have flanges 23 that enclose cover plate 28.

In one embodiment, columnating plate 26 has a pin 50 welded to and protruding from a front thereof. Columnating plate 26 sits inside cover plate 28, with pin 50 extending beyond an end of housing 22. Cover plate 28 has a corresponding hole 52 cut out to receive pin 50. When duct 20 is being assembled, if the position of hole 52 does not align with the position of pin 50, the cover plate 28 will not fit properly. This assures that the correct cover plate 28 is mated with the correct columnating plate 26.

In addition, plenum plate 10 can have one or more flanges 12 in slots 14. Sides and/or flanges 23 of housing 22 can be angled, so that they mate with flanges 12 and thus slots 14. Each duct 20 can have a unique angled side or flange 23 on housing 22. In this way, when housing 22 is inserted into a slot 14, if the parts do not align, the operator will know that the housing 22 and duct 20 need to be connected to a different slot 14.

In another embodiment, duct assembly 1 has support rail 30. Support rail 30 can be connected to front ends of ducts 20, and provide additional mounting stability and support. In addition, pin 50, extending beyond the end of the duct 20, will mate into a notch 32 cut into the support rail 30 at a corresponding position designed to align with the correct position of pin 50. If this position does not align, the duct 20 will not seat properly into the oven, because support rail 30 will not properly align with the end of duct 20. This assures that only correct duct 20 gets placed in the intended position.

It is essential in the present disclose that at least one of the individual parts (i.e., plenum Plate 10, housing 22, columnating plate 26, cover plate 28, support rail 30) have interfitting elements that prevent the parts from mating to other unintended similar parts. There would be many ways of designing these structures, and positioning them in alternate locations in each part. One common design element would be a protrusion on one part (e.g., pin 50 on columnating plate 26) aligning with a clearance on a second mating part, with a potential third or more parts also sharing a corresponding clearance. The shapes for mating the front plenum to the fingers could be any shape as long as it matches the mating part and many shapes (other than the one shown) could be used. Alternatively, an interfering pin and slot design could be used.

Referring again to the Figures, several different embodiments of duct assembly 1 are shown. FIG. 1 depicts an exploded view of duct assembly 1, comprising four upper ducts 20 and four lower ducts 20. Duct assembly 1 is configured such that it prevents incorrect placement of upper and lower impingement ducts 20. Upper support rail 30 is notched and flanged to prevent incorrect placement of upper ducts 20 by causing the alignment of the key, pin and/or tab 50 into the respective slot 52 in either the opposing housing or cover, and then having the key or pin align with the notched portion 32 of upper notched support rail 30. Optionally, lower support rail 30 may be utilized to align with the corresponding keys or pins 50 protruding from the ends of lower ducts 20, thereby ensuring correct placement of ducts 20 in a conveyor oven (not shown).

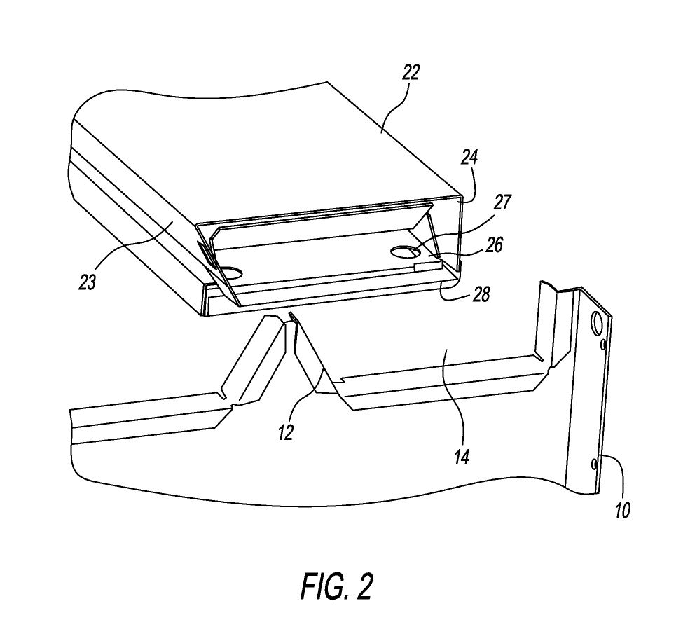

FIG. 2 is perspective view of a first end of a duct 20 adjacent plenum plate 10. As previously discussed, flanges 23 of housing 22 are angled so that they mate with angled flange 12 of slot 14.

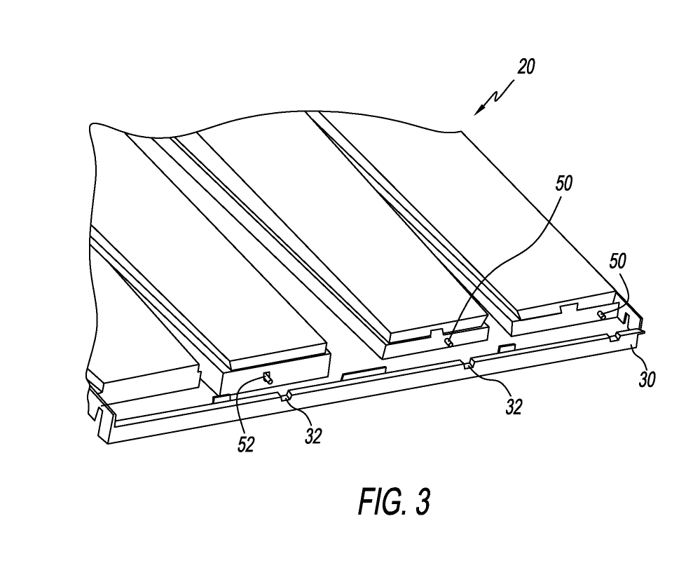

FIG. 3 is a top left-side perspective view of second ends of four upper ducts 20 adjacent upper support rail 30, wherein pins 50 correspond to the position of notches 32 in support rail 30 to provide proper assembly thereof.

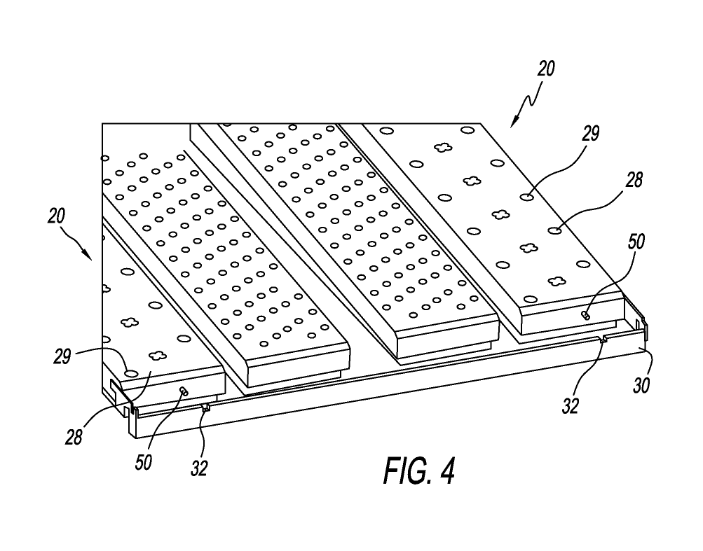

FIG. 4 is a top left-side perspective view of lower ducts 20 adjacent a lower support rail 30. Again, pins 50 align with notches 32 of lower support rail 30 to provide proper assembly thereof.

FIG. 5 depicts notches 32 upper support rail 30. In addition, support rail 30 has one or more raised flanges 34, that also align with the respective key or pin 50 of the respective upper impingement duct 20. This is an additional feature to ensure the correct assembly of duct 20.

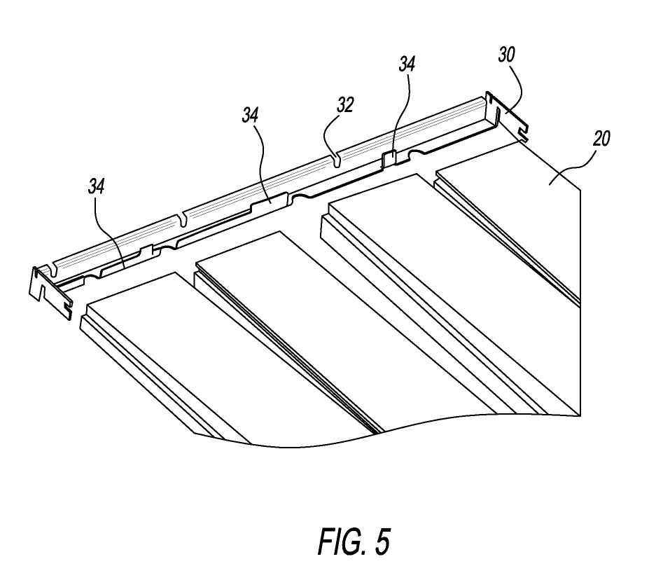

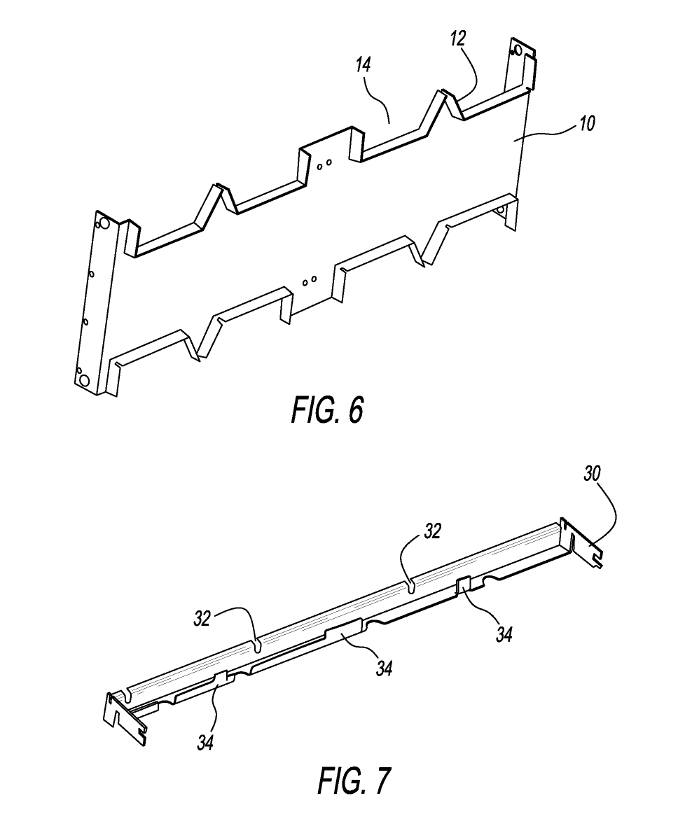

FIG. 6 depicts front plenum plate 10, which as previously discussed has one or more slots 14 to receive ducts 20. Slots 14 each comprise unique angled or shaped flanges 12 to match the housing of each respective impingement duct 20.

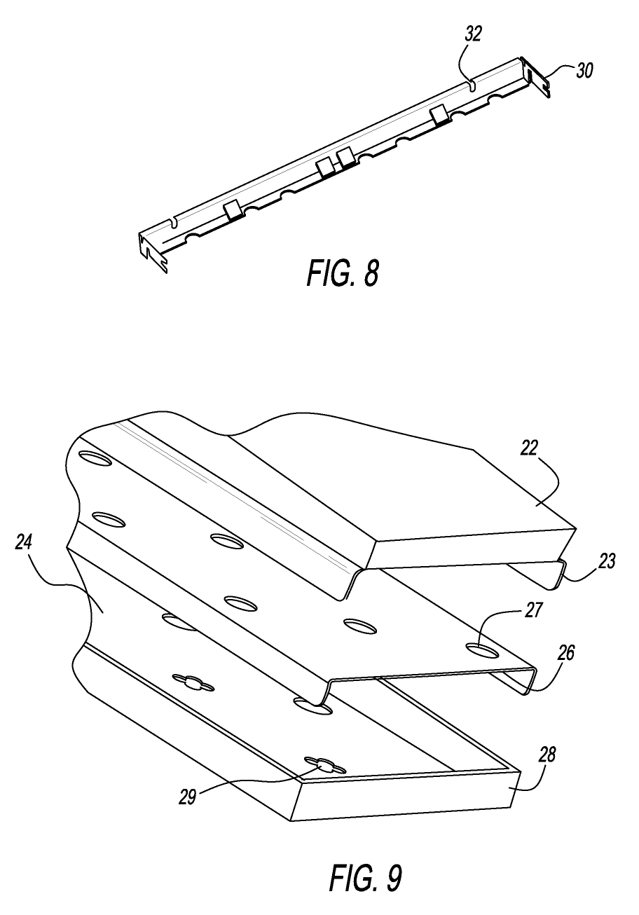

FIG. 7 depicts upper support rail 30 with notches 32, and raised flange 34. Similarly, FIG. 8 depicts a lower support rail 30 with notches 32 to receive the key or pin 50 from lower impingement ducts 20

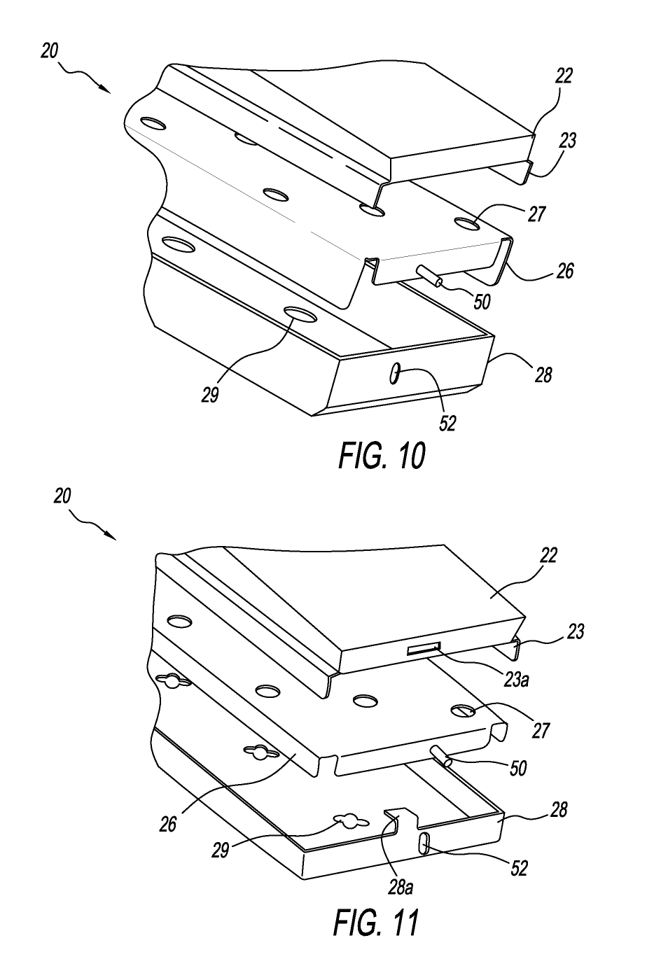

FIG. 9 is an upper impingement duct 20 with angled or shaped housing 22, columnating plate 26, and cover plate 28. In this embodiment, housing 22 is angled (as opposed to flanges 23), which is another way the present disclosure contemplates proper connections between the components of duct assembly 1. FIG. 10 is upper impingement duct 20 with angled or shaped housing 22, columnating plate 26, and with pin 50 protruding from the columnating plate 26. Cover plate 28 has slot 52 disposed therein which is aligned or keyed with pin 50.

FIG. 11 shows another embodiment of the present disclosure. Here, duct 20 has an angled or shaped housing 22, as described above. Housing 22 also has a slot 23a disposed in the end thereof. Columnating plate 26 includes a pin 50 protruding from its end, and cover plate 28 has a slot 52 which is aligned with or keyed to pin 50. Cover plate 28 also includes a tab 28a that matches slot 23a in housing 22 in order to support the correct finger assembly.

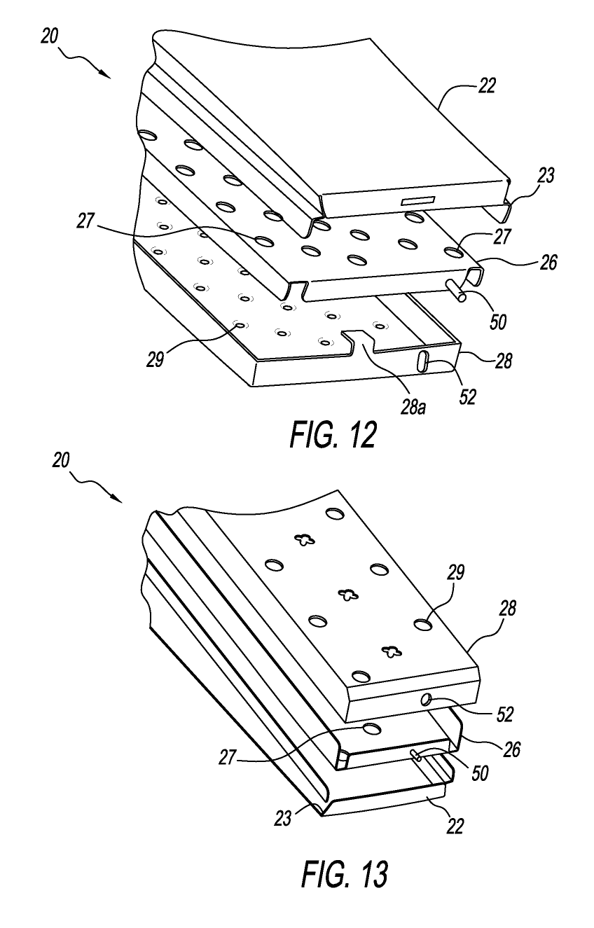

FIG. 12 is an upper impingement duct 20 with an angled or shaped housing 22, and further having a slot 23a for receiving a tab 28a from cover plate 28. In this embodiment, pin 50 is disposed in the right side of the end of columnating plate 26, and it matches a slot 52 disposed on the right side of cover plate 28. Cover plate 28 also includes tab 28a, that matches slot 23a in housing 80.

FIG. 13 is a lower duct 20 with angled or shaped housing 22 and a pin 50 protruding from columnating plate 26. Cover plate 28 also has slot 52, which aligned with pin 52, here disposed on the left side of lower duct 20.

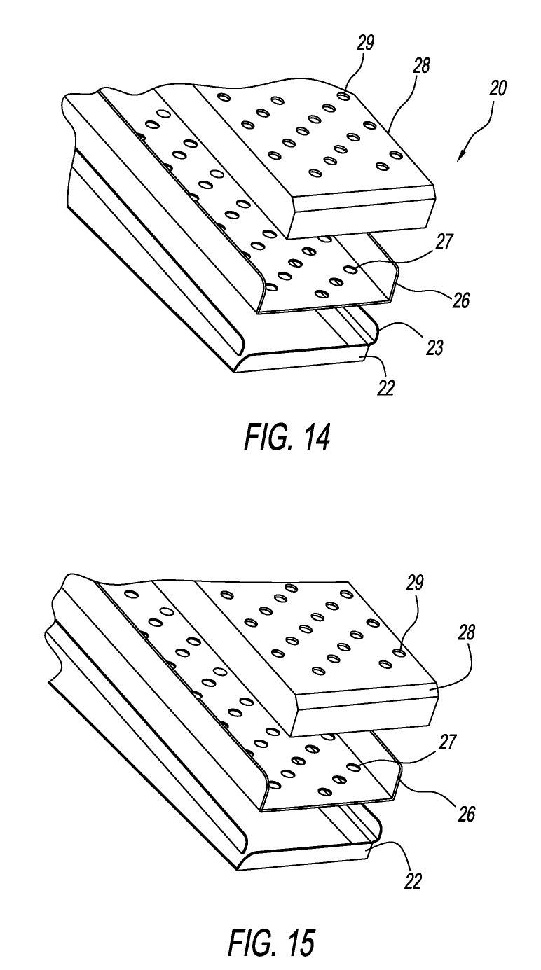

FIG. 14 is a lower impingement duct 20 with an angled or shaped housing 22, columnating plate 26 and cover 28. This particular duct 20 is assembled without any key or pin 50, which may be suitable in certain applications. For example, if this duct 20 is used in an assembly 1 where each of the other ducts 20 have pins 50 or other mating features, a user would be able to determine the proper location of a single duct 20 without those features. This particular duct 20, without a pin 50, can be located to one side of assembly 1. FIG. 15 shows a lower impingement duct 20. Similarly to the upper duct 20 shown in FIG. 14, this particular duct 20 has no pin 50. This duct could also be located to one side of assembly 1.

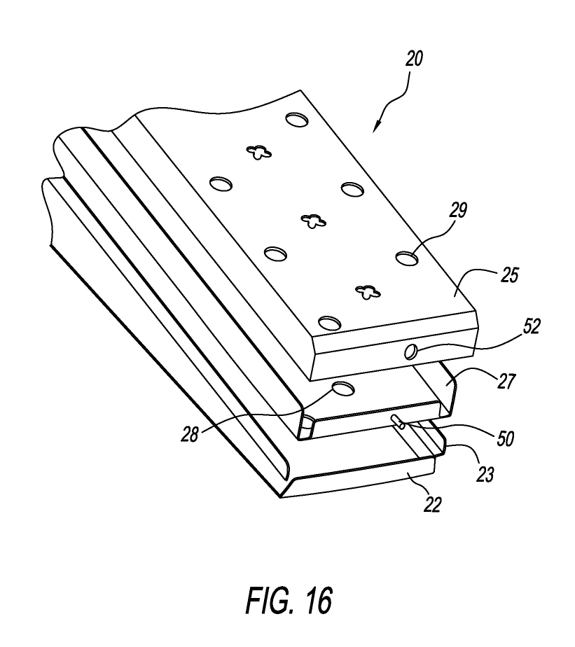

FIG. 16 is another view of a lower impingement duct 20 with an angled or shaped housing 22, a pin 50 protruding from columnating plate 26, and slot 52 in cover 28. Slot 52 is aligned with pin 52 on the left side of assembly 1.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. An impinging air duct, comprising:
a housing;
a columnating plate having one or more columnating orifices; and
a cover plate having one or more cover plate orifices,
wherein said housing, said columnating plate, and said cover plate are connected to one another in stacked vertical alignment, and
wherein at least one of said housing, said columnating plate, and said cover plate comprises a unique mechanical feature that mates with a corresponding feature on another of said housing, said columnating plate, and said cover plate.

2. The duct of claim 1, wherein said columnating plate comprises a protruding pin on a first end thereof that mates with a corresponding slot on said cover plate, when said housing, said columnating plate, and said cover plate are connected to one another.

3. The duct of claim 2, further comprising a support rail connected to at least one of said housing, said columnating plate, and said cover plate, wherein said support rail comprises a notch therein, so that said pin of said columnating plate mates with said notch.

4. The duct of claim 1, wherein said housing comprises a slot therein, and said cover plate comprises a bent flange that mates with said slot.

5. A duct assembly, comprising:
an impingement air duct; and
a plenum plate to receive said impingement duct,
wherein said duct comprises:
a housing;
a columnating plate having one or more columnating orifices; and
a cover plate having one or more cover plate orifices,
wherein said housing, said columnating plate, and said cover plate are connected to one another in stacked vertical alignment, and
wherein at least one of said plenum plate, said housing, said columnating plate, and said cover plate comprises a unique mechanical feature that mates with a corresponding feature on another of said plenum plate, said housing, said columnating plate, and said cover plate.

6. The duct assembly of claim 5, wherein said plenum plate comprises a slot to receive said impingement air duct, and an angled flange in said slot,
wherein said housing comprises an angled portion that corresponds to and mates with said angled flange of said slot when said impingement duct is connected to said plenum plate.

7. The duct assembly of claim 5, wherein said columnating plate comprises a protruding pin on a first end thereof that mates with a corresponding slot on said cover plate, when said housing, said columnating plate, and said cover plate are connected to one another.

8. The duct of claim 7, further comprising a support rail connected to at least one of said housing, said columnating plate, and said cover plate, wherein said support rail comprises a notch therein, so that said pin of said columnating plate mates with said notch.

9. The duct of claim 5, wherein said housing comprises a slot therein, and said cover plate comprises a bent flange that mates with said slot.

10. The duct assembly of claim 5, wherein said impingement air duct is a plurality of impinging air ducts. and said plenum plate comprises a plurality of slots, wherein each slot is configured to receive an associated impinging air duct.

11. The duct assembly of claim 10, wherein each of said slots comprises a unique angled flange in said slot, and a housing of said associated impinging air ducts comprises a unique angled portion that corresponds to and mates with said angled flange of said slot when said impingement duct is connected to said plenum plate, so that said angled portion of said housing will not mate with other slots in said plenum plate.

12. The duct assembly of claim 10, wherein said plurality of impinging air ducts comprises one upper impinging air duct connected to an associated slot on a top side of said plenum plate, and a lower impinging air duct connected to a bottom side of said plenum plate, so that a cover plate of said upper impinging air duct faces a cover plate of said lower impinging air duct.
